(19) United States
(12) Patent Application Publication
(10) Pub. No.: US 2021/0377364 A1
(43) Pub. Date: Dec. 2, 2021

(54) SYNCHRONIZATION OF CUSTOMIZATIONS FOR ENTERPRISE SOFTWARE APPLICATIONS

(71) Applicant: SAP SE, Walldorf (DE)

(72) Inventors: Wulf Kruempelmann, Altlussheim (DE); Susanne Schott, Mannheim (DE)

(21) Appl. No.: 16/885,223

(22) Filed: May 27, 2020

(51) Int. Cl. H04L 29/08; G06F 16/22; G06F 8/76; G06F 8/60

(52) U.S. Cl. CPC H04L 67/34; G06F 8/60; G06F 8/76; G06F 16/2282

(57) ABSTRACT

A method may include receiving, from a development system, a transport request including a configuration data for a software application hosted at a production system. In response to determining that the configuration data corresponds to a mandatory configuration data for the software application, an automatic import transport request may be generated to include the mandatory configuration data. The mandatory configuration data may be deployed to the production system by sending, to the production system, the automatic import transport request including the configuration data. Instead of being held in the template area of the production system, the automatic import transport request may be transferred from the template area of the production system to a data area of the production system where the mandatory configuration data may be automatically deployed without user intervention. Related systems and articles of manufacture, including computer program products, are also provided.

### TECHNICAL FIELD

The present disclosure generally relates to cloud-computing and, more specifically, to synchronizing configuration data for enterprise software applications.

### BACKGROUND

The operations of many organizations may rely on a suite enterprise software applications including, for example, enterprise resource planning (ERP) software, customer relationship management (CRM) software, and/or the like. These enterprise software applications may provide a variety of functionalities including, for example, billing, invoicing, procurement, payroll, time and attendance management, recruiting and onboarding, learning and development, performance and compensation, workforce planning, and/or the like. Some enterprise software applications may be hosted by a cloud-computing platform such that the functionalities provided by the enterprise software applications may be accessed remotely by multiple end users. For example, an enterprise software application may be available as a cloud-based service including, for example, a software as a service (SaaS) and/or the like.

### SUMMARY

Methods, systems, and articles of manufacture, including computer program products, are provided for synchronizing configuration data for an enterprise software application. In one aspect, there is provided a system including at least one processor and at least one memory. The at least one memory can store instructions that cause operations when executed by the at least one processor. The operations may include: receiving, from a development system, a first transport request including a first configuration data for a software application hosted at a production system; determining that the first configuration data corresponds to a mandatory configuration data for the software application; in response to determining that the first configuration data corresponds to the mandatory configuration data, generate an automatic import transport request including the first configuration data; and deploying, to the production system, the mandatory configuration data included in the first transport request by at least sending, to the production system, the automatic import transport request including the first configuration data.

In some variations, one or more of the features disclosed herein including the following features can optionally be included in any feasible combination. A second transport request including a second configuration data for the software application hosted at the production system may be received from the development system. The second configuration data may be determined to correspond to a non-mandatory configuration data for the software application. In response to determining that the second configuration data corresponds to the non-mandatory configuration data, the non-mandatory configuration data included in the second transport request may be deployed to the production system by at least sending, to the production system, the second transport request including the second configuration data.

In some variations, the automatic import transport request may be transferred from a template area of the production system to a data area of the production system where the first configuration data is deployed without user intervention. The second transport request may be held in the template area of the production system until a user deploys the second configuration data.

In some variations, the automatic import transport request may be transferred to the data area of the production system based at least on the automatic import transport request being tagged as including configuration settings.

In some variations, the software application may operate on data stored in one or more database tables. The first configuration data may include a template defining a manner in which the data is stored in the one or more database tables.

In some variations, the first configuration data may be determined to correspond to the mandatory configuration data based at least on a whitelist identifying one or more mandatory configuration data.

In some variations, the first configuration data may be determined to correspond to the mandatory configuration data based at least on a blacklist identifying one or more non-mandatory configuration data.

In some variations, the mandatory configuration data may implement a change to a country, a currency, and/or a measurement unit.

In some variations, the software application may be an enterprise resource planning (ERP) software and/or a customer relationship management (CRM) software.

In some variations, the production system may be a cloud-computing platform.

In another aspect, there is provided a method for synchronizing configuration data for an enterprise software application. The method may include: receiving, from a development system, a first transport request including a first configuration data for a software application hosted at a production system; determining that the first configuration data corresponds to a mandatory configuration data for the software application; in response to determining that the first configuration data corresponds to the mandatory configuration data, generate an automatic import transport request including the first configuration data; and deploying, to the production system, the mandatory configuration data included in the first transport request by at least sending, to the production system, the automatic import transport request including the first configuration data.

In some variations, one or more of the features disclosed herein including the following features can optionally be included in any feasible combination. The method may further include: receiving, from the development system, a second transport request including a second configuration data for the software application hosted at the production system; determining that the second configuration data corresponds to a non-mandatory configuration data for the software application; and in response to determining that the second configuration data corresponds to the non-mandatory configuration data, deploying, to the production system, the non-mandatory configuration data included in the second transport request by at least sending, to the production system, the second transport request including the second configuration data.

In some variations, the automatic import transport request may be transferred from a template area of the production system to a data area of the production system where the first configuration data is deployed without user intervention. The second transport request may be held in the template area of the production system until a user deploys the second configuration data.

In some variations, the automatic import transport request may be transferred to the data area of the production system based at least on the automatic import transport request being tagged as including configuration settings.

In some variations, the software application may operate on data stored in one or more database tables. The first configuration data may include a template defining a manner in which the data is stored in the one or more database tables.

In some variations, the first configuration data may be determined to correspond to the mandatory configuration data based at least on a whitelist identifying one or more mandatory configuration data.

In some variations, the first configuration data may be determined to correspond to the mandatory configuration data based at least on a blacklist identifying one or more non-mandatory configuration data.

In some variations, the mandatory configuration data may implement a change to a country, a currency, and/or a measurement unit.

In some variations, the software application may be an enterprise resource planning (ERP) software and/or a customer relationship management (CRM) software. The production system may be a cloud-computing platform.

In another aspect, there is provided a computer program product that includes a non-transitory computer readable medium. The non-transitory computer readable medium may store instructions that cause operations when executed by at least one data processor. The operations may include: receiving, from a development system, a first transport request including a first configuration data for a software application hosted at a production system; determining that the first configuration data corresponds to a mandatory configuration data for the software application; in response to determining that the first configuration data corresponds to the mandatory configuration data, generate an automatic import transport request including the first configuration data; and deploying, to the production system, the mandatory configuration data included in the first transport request by at least sending, to the production system, the automatic import transport request including the first configuration data.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to synchronizing configuration data for enterprise software applications, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of a configuration system, in accordance with some example embodiments;

FIG. 2 depicts a block diagram illustrating an example data flow within a configuration system, in accordance with some example embodiments;

FIG. 3 depicts a flowchart illustrating an example of a process for synchronizing configuration data for an enterprise software application, in accordance with some example embodiments; and

FIG. 4 depicts a block diagram illustrating a computing system, in accordance with some example embodiments.

When practical, like labels are used to refer to same or similar items in the drawings.

### DETAILED DESCRIPTION

An enterprise software application may operate on data stored in one or more database tables. As such, the enterprise software application may be implemented based on configuration data including, for example, a template defining the manner in which data is stored in the database tables. A developer of the enterprise software application may deliver, to an end user, the enterprise software application with a template library including a set of templates. The end user may subsequently select, based on individual requirements, one or more of the templates from the template library. Moreover, the end user may further customize the enterprise software application by applying, to the selected template, one or more end user specific customizations prior to deploying the customized enterprise software application to that end user's production system. For example, the customized enterprise software application may be deployed by at least sending, to the end user's production system, a transport request including configuration data capturing the end user's customizations to the enterprise software application. The customized enterprise software application may be deployed to a cloud-computing platform such that the functionalities of the customized enterprise software application are remotely accessible from one or more thin clients (e.g., a web browser, a native application, and/or the like).

The developer of the enterprise software application may provide additional customizations for the enterprise software application deployed at the end user's production system. Accordingly, the developer may send, to the end user's production system, one or more transport requests including configuration data implementing the additional customizations to the enterprise software application. However, a conventional transport request from the developer may be held in a template area of the end user's production system until the end user deploys the configuration data included in the transport request. Conventional transport requests may therefore be unsuitable for transporting mandatory configuration data associated implementing customizations that require immediate deployment at the end user's production system.

As such, in some example embodiments, a transport collector may be configured to collect, from a development system, one or more transport requests including configuration data for the enterprise software application deployed at the end user's production system. The transport collector may identify, within each of the transport request, mandatory configuration data that require immediate deployment to the end user's production system. Mandatory configuration data may implement legally mandated customizations such as, for example, changes to countries, currencies, measurement units, and/or the like. The transport collect may generate an automatic import transport request including the mandatory configuration data. Unlike a conventional transport request, which may be held indefinitely in the template area of the end user's production system, the automatic import transport request may be moved automatically from the template area of the end user's production system to a data area of the end user's production system. From there, the contents of the automatic import transport request may be deployed automatically without any intervention from the end user.

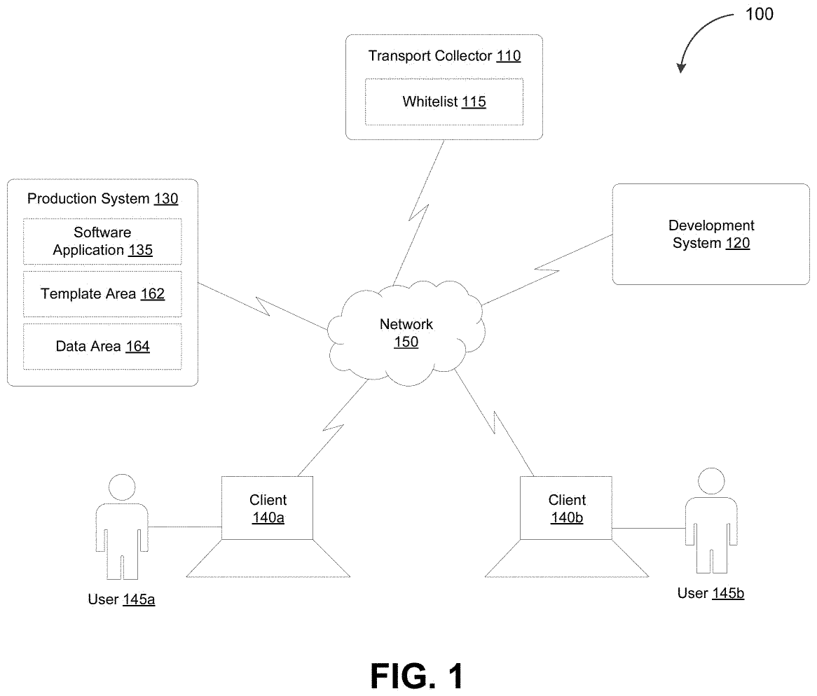

FIG. 1 depicts a system diagram illustrating an example of a configuration system 100, in accordance with some example embodiments. Referring to FIG. 1, the configuration system 100 may include a transport collector 110, a development system 120, a production system 130, a first client 140a, and a second client 140b. As shown in FIG. 1, the transport collector 110, the development system 120, the production system 130, the first client 140a, and the second client 140b may be communicatively coupled via a network 150. The network 150 may be a wired and/or wireless network including, for example, a wide area network (WAN), local area network (LAN), a virtual local area network (VLAN), the Internet, and/or the like.

The production system 130 may host a software application 135. Moreover, the production system 130 may be a cloud-based system hosted on a cloud-computing platform such that the functionalities of the software application 135 are remotely accessible from one or more thin clients including, for example, a web browser, a native application, and/or the like. The software application 135 may be an enterprise resource planning (ERP) software application, a customer relationship management (CRM) software application, and/or the like. As such, the software application 135 may provide a variety of data processing functionalities including, for example, payroll, time and attendance management, recruiting and onboarding, learning and development, performance and compensation, workforce planning, and/or the like. In order to perform a data processing functionalities, the software application 135 may operate on data stored in one or more database tables. Accordingly, the software application 135 may be implemented based on configuration data that includes a template defining the manner in which data is stored in the one or more database tables.

A first user 145a at the first client 140a may interact with the development system 120 in order to implement one or more customizations to add, remove, and/or modify one or more functionalities of the software application 135 at the production system 130. As noted, the configuration data associated with the software application 135 may include a template defining the manner in which data is stored in the one or more database tables operated upon by the software application 135. Accordingly, to implement customizations for the software application 135, the first user 145a at the first client 140a may generate configuration data that includes a different template for the database tables operated upon by the software application 135. The configuration data may be sent to the production system 130 in a transport request before being deployed at the production system 130.

Table 1 below depicts pseudo programming code for a template defining the manner in which data is stored in a database table. In the example shown in Table 1, the template may include extensible markup language (XML) defining the manner in which data is stored in a database table.

TABLE 1

<item>
<object_name> manufacturing method </object_name>
<object_type> table_content</object_type>
<table_name>tab_manufacuring</table_name>
<field> method</field>
<content>batch</content>
<field>product</field>
<content>medicine</content>
</item>

Each transport request may include mandatory configuration data, which may implement legally mandated customizations such as changes to countries, currencies, measurement units, and/or the like. Alternatively and/or additionally, each transport request may include non-mandatory configuration data that implements non-mandatory customizations. Unlike non-mandatory configuration data, which may be deployed at the production system 130 at any time, mandatory configuration data may require immediate deployment at the production system 130. However, a conventional transport request from the development system 120 may be held in a template area 162 of the production system 130 until, for example, a second user 145b at a second client 140b interacts with the production system 130 to deploy the configuration data included in the transport request. Including mandatory configuration data in a conventional transport request may therefore delay the deployment of the mandatory configuration data or prevent the mandatory configuration data from being deployed altogether.

As such, in some example embodiments, the transport collector 110 may be configured to collect the one or more transport requests generated at the development system 120. The transport collector 110 may identify, within each transport request, mandatory configuration data. For example, mandatory configuration data may be identified based at least on a whitelist 115 identifying one or more mandatory configuration data. As such, the configuration data included in the one or more transport requests may be identified as mandatory (or non-mandatory) configuration data based on whether the configuration data is present in the whitelist 115. Alternatively and/or additionally, the configuration data included in the one or more transport requests may be identified as mandatory (or non-mandatory) configuration data based on whether the configuration data is present in a blacklist identifying one or more non-mandatory configuration data. For instance, a configuration data may be identified as mandatory configuration data by being present in the whitelist 115 and/or being absent from the blacklist.

The transport collector 110 may generate an automatic import transport request that includes the mandatory configuration data. Unlike a conventional transport request, which may be held indefinitely in the template area 162 of the production system 130, the automatic import transport request may be moved automatically from the template area 162 of the production system 130 to a data area 164 of the production system 130. Once the automatic import transport request is moved to the data area 164, the mandatory configuration data included in the automatic import transport request may be deployed automatically without any intervention from the second user 145b at the second client 140b.

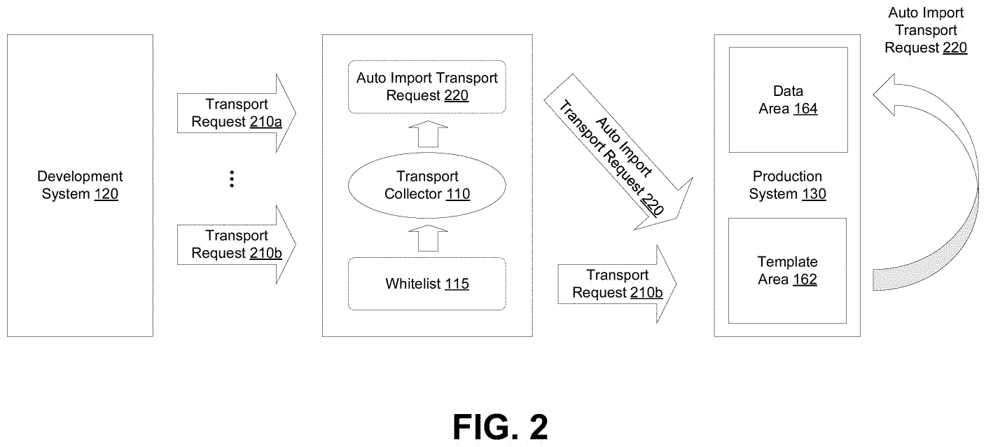

FIG. 2 depicts a block diagram illustrating an example data flow within the configuration system 100, in accordance with some example embodiments. Referring to FIGS. 1-2, the transport collector 110 may receive, from the development system 120, one or more transport requests including, for example, a first transport request 210a, a second transport request 210b, and/or the like. The first transport request 210a and the second transport request 210b may each include configuration data implementing one or more customizations for the software application 135 hosted at the production system 130. For example, the software application 135 may operate on data stored in one or more database tables. As such, the configuration data included in each of the first transport request 210a and the second transport request 210b may include a template defining the manner in which data is stored in the one or more database tables operated upon by the software application 135.

In some example embodiments, the transport collector 110 may determine, based at least on the whitelist 115, that at least some of the configuration data included in the first transport request 210a is mandatory configuration data while the configuration data included in the second transport request 210b is non-mandatory configuration data. As noted, mandatory configuration data may implement legally mandated customizations such as changes to countries, currencies, measurement units, and/or the like. Moreover, mandatory configuration data may require immediate deployment at the production system 130. Accordingly, as shown in FIG. 2, the transport collector 110 may generate an automatic import transport request 220 to include the mandatory configuration data included in the first transport request 210a. For example, the mandatory configuration data included in the first transport request 210a may be moved to the automatic import transport request 220 while any non-mandatory configuration data may remain in the first transport request 210a. Furthermore, the transport collector 110 may send, to the production system 130, the first transport request 210a including the non-mandatory configuration data remaining in the first transport request 210a, the second transport request 210b, as well as the automatic import transport request 220 including the mandatory configuration data from the first transport request 210a.

In some example embodiments, the first transport request 210a including the non-mandatory configuration data remaining in the first transport request 210a, the second transport request 210b, and the automatic import transport request 220 including the mandatory configuration data from the first transport request 210a may be delivered to the template area 162 of the production system 130. However, while the first transport request 210a and the second transport request 210b may be held in the template area 162 until the second user 145b at the second client 140b deploys the non-mandatory configuration data included in the first transport request 210a and the second transport request 210b, the automatic import transport request 220 may be moved to the data area 164 of the production system 130. For example, the production system 130 may move the automatic import transport request 220 from the template area 162 to the data area 164 based at least on the automatic import transport request 220 being tagged as including configuration settings, which are associated with a transport setting that requires the automatic import transport request 220 to be transferred to the data area 164 of the production system 130.

Once the automatic import transport request 220 is moved to the data area 164 of the production system 130, the mandatory configuration data included in the automatic import transport request 220 may be deployed automatically without any intervention from the second user 145b at the second client 140b. Contrastingly, the deployment of the non-mandatory customizations included in the first transport request 210a and the second transport request 210b may be delayed as the first transport request 210a and the second transport request 210b may be held indefinitely in the template area 162 of the production system 130.

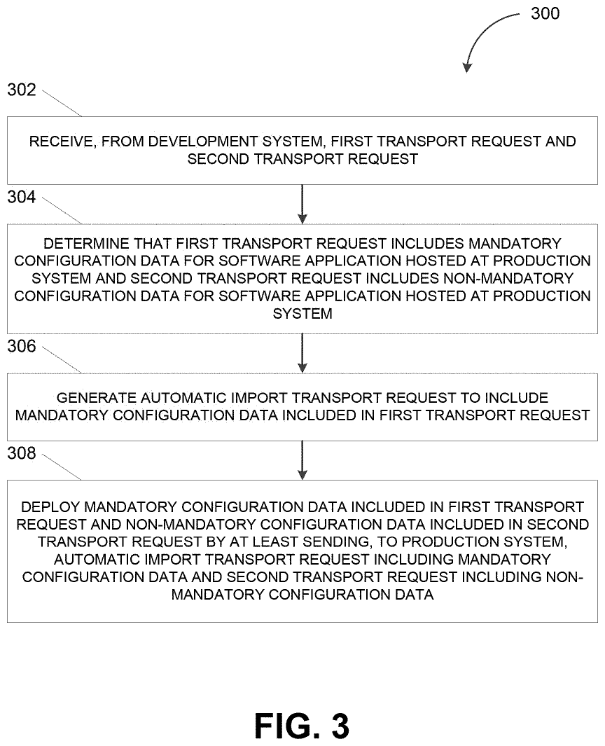

FIG. 3 depicts a flowchart illustrating an example of a process 300 for synchronizing configuration data for an enterprise software application, in accordance with some example embodiments. Referring to FIGS. 1-3, the process 300 may be performed by the transport collector 110 in order to deploy, at the production system 130, mandatory configuration data as well as non-mandatory configuration data implementing customizations for the software application 135 hosted at the production system 130.

At 302, the transport collector 110 may receive, from the development system 120, a first transport request and a second transport request. In some example embodiments, the first user 145a at the first client 140a may interact with the development system 120 in order to implement one or more customizations to add, remove, and/or modify one or more functionalities of the software application 135 at the production system 130. For example, the first user 145a at the first client 140a may generate configuration data that includes a different template for the database tables operated upon by the software application 135. The configuration data customizing the software application 135 may be sent to the production system 130 in one or more transport requests. For example, as shown in FIG. 2, the development system 120 may send, to the production system 130, the first transport request 210a and the second transport request 210b.

At 304, the transport collector 110 may determine that the first transport request includes mandatory configuration data for the software application 135 hosted at the production system 130 and the second transport request includes non-mandatory configuration data for the software application 135 hosted at the production system 130. In some example embodiments, the whitelist 115 may identify one or more mandatory configuration data implementing legally mandated customizations such as changes to countries, currencies, measurement units, and/or the like. The transport collector 110 may determine, based at least on the whitelist 115, that the first transport request 210a includes mandatory configuration data. Alternatively and/or additionally, the transport collector 110 may determine, based at least on the whitelist 115, that the second transport request 210b includes non-mandatory configuration data. As noted, the transport collector 110 may also use a blacklist identifying one or more non-mandatory configuration data in order to determine that the first transport request 210a includes mandatory configuration data and that the second transport request 210b includes non-mandatory configuration data.

At 306, the transport collector 110 may generate an automatic import transport request to include the mandatory configuration data included in the first transport request. In some example embodiments, the transport collector 110 may generate the automatic import transport request 220 to include the mandatory configuration data included in the first transport request 210a. Doing so may ensure that the mandatory configuration data included in the first transport request 210a are immediately deployed at the production system 130 instead of being held indefinitely in the template area 162 of the production system 130 at least because the automatic import transport request 220 may be tagged as including configuration settings that are transferred automatically to the data area 164 of the production system 130 for deployment.

At 308, the transport collector 110 may deploy the mandatory configuration data included in the first transport request and the non-mandatory configuration data included in the second transport request by at least sending, to the production system 130, the automatic import transport request including the mandatory configuration data and the second transport request including the non-mandatory configuration data. For example, as shown in FIG. 2, the transport collector 110 may send, to the production system 130, the automatic import transport request 220, which includes the mandatory configuration data included in the first transport request 210a. Furthermore, FIG. 2 shows that the transport collector 110 may send, to the production system 130, the second transport request 210b including non-mandatory configuration data implementing non-mandatory customizations for the software application 135 at the production system 130. In some example embodiments, the second transport request 210b may be held in the template area 162 of the production system 130 until the second user 145b at the second client 140b deploys the non-mandatory configuration data included in the second transport request 21b.

Contrastingly, upon being delivered to the template area 162 of the production system 130, the automatic import transport request 220 may be transferred to the data area 164 of the production system 130 based at least on the automatic import transport request 220 being tagged as including configuration settings. Once the automatic import transport request 220 is transferred to the data area 164 of the production system 130, the mandatory configuration data included in the automatic import transport request 220 may be deployed automatically without intervention from the second user 145b at the second client 140b.

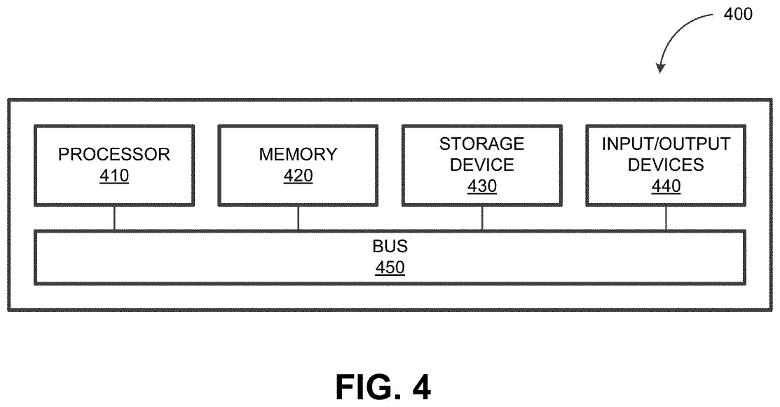

FIG. 4 depicts a block diagram illustrating a computing system 400 consistent with implementations of the current subject matter. Referring to FIGS. 1-4, the computing system 400 can be used to implement the transport collector 110 and/or any components therein.

As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The processor 410 is capable of processing instructions for execution within the computing system 400. Such executed instructions can implement one or more components of, for example, the transport collector 110. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a solid-state device, a floppy disk device, a hard disk device, an optical disk device, a tape device, and/or any other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions, which when executed by the at least one data processor, result in operations comprising:
receiving, from a development system, a first transport request including a first configuration data for a software application hosted at a production system;
determining that the first configuration data corresponds to a mandatory configuration data for the software application;
in response to determining that the first configuration data corresponds to the mandatory configuration data, generate an automatic import transport request including the first configuration data; and
deploying, to the production system, the mandatory configuration data included in the first transport request by at least sending, to the production system, the automatic import transport request including the first configuration data.

2. The system of claim 1, further comprising:
receiving, from the development system, a second transport request including a second configuration data for the software application hosted at the production system;
determining that the second configuration data corresponds to a non-mandatory configuration data for the software application; and
in response to determining that the second configuration data corresponds to the non-mandatory configuration data, deploying, to the production system, the non-mandatory configuration data included in the second transport request by at least sending, to the production system, the second transport request including the second configuration data.

3. The system of claim 2, wherein the automatic import transport request is transferred from a template area of the production system to a data area of the production system where the first configuration data is deployed without user intervention, and wherein the second transport request is held in the template area of the production system until a user deploys the second configuration data.

4. The system of claim 3, wherein the automatic import transport request is transferred to the data area of the production system based at least on the automatic import transport request being tagged as including configuration settings.

5. The system of claim 1, wherein the software application operates on data stored in one or more database tables, and wherein the first configuration data includes a template defining a manner in which the data is stored in the one or more database tables.

6. The system of claim 1, wherein the first configuration data is determined to correspond to the mandatory configuration data based at least on a whitelist identifying one or more mandatory configuration data.

7. The system of claim 1, wherein the first configuration data is determined to correspond to the mandatory configuration data based at least on a blacklist identifying one or more non-mandatory configuration data.

8. The system of claim 1, wherein the mandatory configuration data implements a change to a country, a currency, and/or a measurement unit.

9. The system of claim 1, wherein the software application comprises an enterprise resource planning (ERP) software and/or a customer relationship management (CRM) software.

10. The system of claim 1, wherein the production system comprises a cloud-computing platform.

11. A computer-implemented method, comprising:
receiving, from a development system, a first transport request including a first configuration data for a software application hosted at a production system;
determining that the first configuration data corresponds to a mandatory configuration data for the software application;
in response to determining that the first configuration data corresponds to the mandatory configuration data, generate an automatic import transport request including the first configuration data; and
deploying, to the production system, the mandatory configuration data included in the first transport request by at least sending, to the production system, the automatic import transport request including the first configuration data.

12. The method of claim 11, further comprising:
receiving, from the development system, a second transport request including a second configuration data for the software application hosted at the production system;
determining that the second configuration data corresponds to a non-mandatory configuration data for the software application; and
in response to determining that the second configuration data corresponds to the non-mandatory configuration data, deploying, to the production system, the non-mandatory configuration data included in the second transport request by at least sending, to the production system, the second transport request including the second configuration data.

13. The method of claim 12, wherein the automatic import transport request is transferred from a template area of the production system to a data area of the production system where the first configuration data is deployed without user intervention, and wherein the second transport request is held in the template area of the production system until a user deploys the second configuration data.

14. The method of claim 13, wherein the automatic import transport request is transferred to the data area of the production system based at least on the automatic import transport request being tagged as including configuration settings.

15. The method of claim 11, wherein the software application operates on data stored in one or more database tables, and wherein the first configuration data includes a template defining a manner in which the data is stored in the one or more database tables.

16. The method of claim 11, wherein the first configuration data is determined to correspond to the mandatory configuration data based at least on a whitelist identifying one or more mandatory configuration data.

17. The method of claim 11, wherein the first configuration data is determined to correspond to the mandatory configuration data based at least on a blacklist identifying one or more non-mandatory configuration data.

18. The method of claim 11, wherein the mandatory configuration data implements a change to a country, a currency, and/or a measurement unit.

19. The method of claim 11, wherein the software application comprises an enterprise resource planning (ERP) software and/or a customer relationship management (CRM) software, and wherein the production system comprises a cloud-computing platform.

20. A non-transitory computer readable medium storing instructions, which when executed by at least one data processor, result in operations comprising:
receiving, from a development system, a first transport request including a first configuration data for a software application hosted at a production system;
determining that the first configuration data corresponds to a mandatory configuration data for the software application;
in response to determining that the first configuration data corresponds to the mandatory configuration data, generate an automatic import transport request including the first configuration data; and
deploying, to the production system, the mandatory configuration data included in the first transport request by at least sending, to the production system, the automatic import transport request including the first configuration data.
